(19) United States
(12) Patent Application Publication
(10) Pub. No.: US 2005/0067827 A1
(43) Pub. Date: Mar. 31, 2005

(54) Seat security arrangement comprising a safety belt with lateral seat occupant support

(75) Inventors: Ola Bostrom, Alingsas (SE); Yngve Haland, Falsterbo (SE)

Correspondence Address: ROBERT W. BECKER & ASSOCIATES;Suite B, 707 Highway 66 East, Tijeras, NM, 87059, US

(73) Assignee: Autoliv Development AB, Vargarda (SE)

(21) Appl. No.: 10/727,404

(22) Filed: Dec. 4, 2003

(30) Foreign Application Priority Data
Sep. 25, 2003 (DE) 203 14 924.6

(51) Int. Cl. B60R 22/48; B60R 22/00

(52) U.S. Cl. 280/801.1; 280/808

(57) ABSTRACT

A seat security arrangement for a vehicle seat occupant sitting on a vehicle seat. The arrangement includes a three-point safety belt having an extent forming a shoulder belt extending from the outboard side of the vehicle seat that restrains one shoulder of the seat occupant and another extent forming a lap belt. The arrangement further includes a two-point safety belt extending from the inboard side of the vehicle seat past the respective non-belt restrained shoulder of the seat occupant and thereafter crossing the shoulder belt of the three-point safety belt. Additionally, the arrangement includes a support device located in the respective region of the seat back turned toward the inboard side of the vehicle seat, the support device extending in the direction of the vehicle's forward travel so as provide lateral support to the upper torso of the seat occupant.

### BACKGROUND OF THE INVENTION

The present invention relates to a seat security arrangement for a vehicle seat occupant sitting on a vehicle seat, the arrangement comprising a three-point safety belt having a lap belt and a shoulder belt and further comprising an additional two-point shoulder belt that extends past the respective non-belt restrained shoulder of the seat occupant and crosses the shoulder belt of the three-point safety belt.

A seat security arrangement having the above-noted features is disclosed in U.S. Pat. No. 5,123,673. With respect to the seat security arrangement disclosed in that patent, initially a three-point safety belt is secured relative to a vehicle seat, the three-point safety belt comprising a shoulder belt unwindable from a seatbelt roller disposed in the seat back through a slot located in the seat back in the area of a shoulder of the seat occupant to thereafter extend over the shoulder and the chest area of a seat occupant sitting on the vehicle seat to the opposed side of the vehicle seat, whereat the direction of the seatbelt reverses as the seatbelt is trained through a lockable buckle tongue of a belt buckle secured to the vehicle side of the seat and the seatbelt thereafter extends as a lap belt over the abdomen of the seat occupant to a seat-side mounted belt anchorage. This arrangement of the three-point belt is configured such that the belt take-up roller and the belt anchorage are disposed on the side of the seat adjacent to the vehicle door.

In view of the fact that, in the event of a side impact on the respective side of the vehicle that is opposite to the side of the vehicle at which the seat with the three-point safety belt is located, there is a risk that the seat occupant will be pivoted out of the shoulder belt of the three-point safety belt due to the force component directed toward the vehicle interior, the above-described state-of-the-art arrangement is additionally provided with a two-point belt which extends as a shoulder belt from a belt take-up roller integrated into the shoulder region of the seat back over the chest area of the seat occupant to a seatbelt closure located in the region of the belt anchorage of the three-point safety belt and, in this manner, extends transversely across the shoulder belt of the three-point belt. This additional two-point belt prevents a pivoting of the seat occupant out of the shoulder belt of the three-point belt.

However, this just-noted conventional seat security arrangement has the disadvantage that the belt edge of the two-point belt, which frequently extends across the neck region of the seat occupant, can cause considerable injury for the reason that, in the event of a side impact, the respective force component in the direction of the vehicle interior side effects a movement of the seat occupant into the two-point belt.

### SUMMARY OF THE INVENTION

The present invention offers a solution to the challenge of providing a seat security arrangement having the above-noted state of the art features which, however, better supports and protects the seat occupant against the consequences of a side impact.

The present invention provides, in its core concept, that, in the region of the seat back turned toward the vehicle interior side, a support device is provided that extends forwardly from the seat back in the vehicle driving direction and which laterally supports the upper torso of the seat occupant. The advantage is provided by the present invention that the lateral or sideways movement of the seat occupant out of the three-point belt is caught by the additional support device that provides its additional support in the region of the two-point belt located in opposition to the three-point safety belt.

In accordance with one embodiment of the present invention, the support device is a non-moving fixed support. In this connection, the support can be configured in the form of a frame supported laterally on the seat back.

Alternatively, it can be additionally provided, in accordance with the present invention, that the support device is able to assume its supporting position in the event of a sensed or detected impact event, with the support device being, in the normal operation of the vehicle, not at all or, at most, only scarcely, visible. A support device of this type can, in this connection, be mounted in the seat back or, as well, can be mounted in a lateral armrest and extended therefrom to provide support. Also, it is possible to mount the support device on the outer side of the seat back in a manner such that the support device does not project beyond the contour of the seat back. In this connection, it can be provided, for example, that the frame of the support device, in its non-deployed position, assumes a rearward position relative to the seat back and, in the event of an impact, is disposable by means of a displacement movement into its forward deployed support position.

To the extent that a frame of the just-noted displaceable configuration is provided, it is possible to configure the frame with a belt guide for the shoulder belt of the two-point safety belt arrangement.

A frame of the above-type also provides the possibility, in connection with another embodiment of the present invention, to integrate into the frame an airbag module having an airbag that unfolds out of the frame in the event of an impact.

It can be further provided that the frame also has an energy absorption function, whereby either the frame itself is configured to yield or, alternatively, the bracket supporting the frame on the seat back is configured to yield; it is to be understood that, as well, both of these alternative possibilities can be combined with one another.

In accordance with an embodiment of the present invention, it is provided that the support device comprises an airbag that unfolds out of the side region of the seat back toward the front of the vehicle in the event of a detected impact. In this connection, it can be provided that the airbag module, which accommodates the airbag and gas generator, is mounted on the side wall of the seat back; to the extent that a middle armrest is provided in the vehicle, the airbag module can, as well, be mounted in the middle armrest.

In order to improve the lateral support function of the airbag module, it can be provided that the cover of the airbag module, which opens in connection with the airbag deployment and is mounted on the side of the airbag module disposed away from the seat back, is configured such that the cover, in its opened-out position, extends forwardly and provides a lateral or sidewise support for the deployed airbag.

### BRIEF DESCRIPTION OF THE DRAWINGS

One embodiment of the present invention is described in the following description having reference to the figures of the drawings.

FIG. 1 is a perspective view of one embodiment of the seat security arrangement and a support device of the present invention on a vehicle seat;

FIG. 2 is a side elevational view of the vehicle seat shown in FIG. 1 with a seat occupant in the vehicle seat and showing the side of the vehicle seat having the two-point belt with the support device oriented with respect thereto;

FIG. 3 is a side elevational view of the frame of the support device configured as a fixedly mounted frame;

FIG. 4 is a side elevational view of the frame of the support device in an alternative displaceable configuration;

FIG. 5 is a side elevational view of a vehicle seat with a seat occupant in the seat and a support device of the present invention configured as an unfoldable airbag;

FIG. 6 is a top plan view in partial section of the seat back of the vehicle seat having the support device of the embodiment shown in FIG. 5; and

FIG. 7 is a top plan view in partial section of the seat back of the vehicle seat having the support device of the embodiment shown in FIG. 5 and showing the forwardly deployed airbag and the disposition of the cover of the airbag module following the deployment of the airbag.

### DETAILED DESCRIPTION OF THE PREFERRED EMBODIMENT

As shown in FIG. 1, one embodiment of the seat security arrangement of the present invention is mounted relative to a vehicle seat having a seat surface 11 and a seat back 12. A three-point belt 13 is disposed relative to the vehicle seat, the three-point belt 13 having a shoulder belt 14 which extends to a buckle 15 whereat the direction of the belt is changed such that the belt thereafter extends as a lap belt 16 to a belt anchorage 17. A belt take-up roller is mounted in a non-illustrated manner in the region of the seat back 12 for the taking up, and unwinding therefrom, of the shoulder belt 14 of the three-point belt 13, whereby the corresponding belt band extends out of a belt slot 38 on the seat back and, initially, extends along the seatback to a change of direction element in the region of the upper torso of the seat occupant, the change of direction element being configured as a frame 18 for the three-point belt 13.

Moreover, a two-point belt 19 is mounted relative to the vehicle seat 10, the two-point belt 19 having a shoulder belt 20 which extends from a frame 22 operating as a support device transversely across the shoulder belt 14 of the three-point belt to a belt buckle 21 for the two-point belt 19 mounted in the region of the belt anchorage 17. As can be seen in individual detail in FIG. 2, the support device in its configuration as the frame 22 comprises a belt guide 23 by means of which the direction of the shoulder belt 20 of the two-point belt 19 is changed from the respective path that it follows upon exiting through an exit slot 25 as it unwinds from a belt take-up roller 24 mounted in the region of the seat back 12 to its subsequent path across the upper body 36 of the belted-in seat occupant 35.

As can be clearly seen, in the event of an application of a force in the direction of the arrow 37 (see FIG. 1) as the result of a side impact, the upper torso 36 of the seat occupant 35 cannot pivot out of the three-point belt 13, because the support device provided in accordance with the present invention, which is configured as the frame 22, prevents this pivoting-out movement.

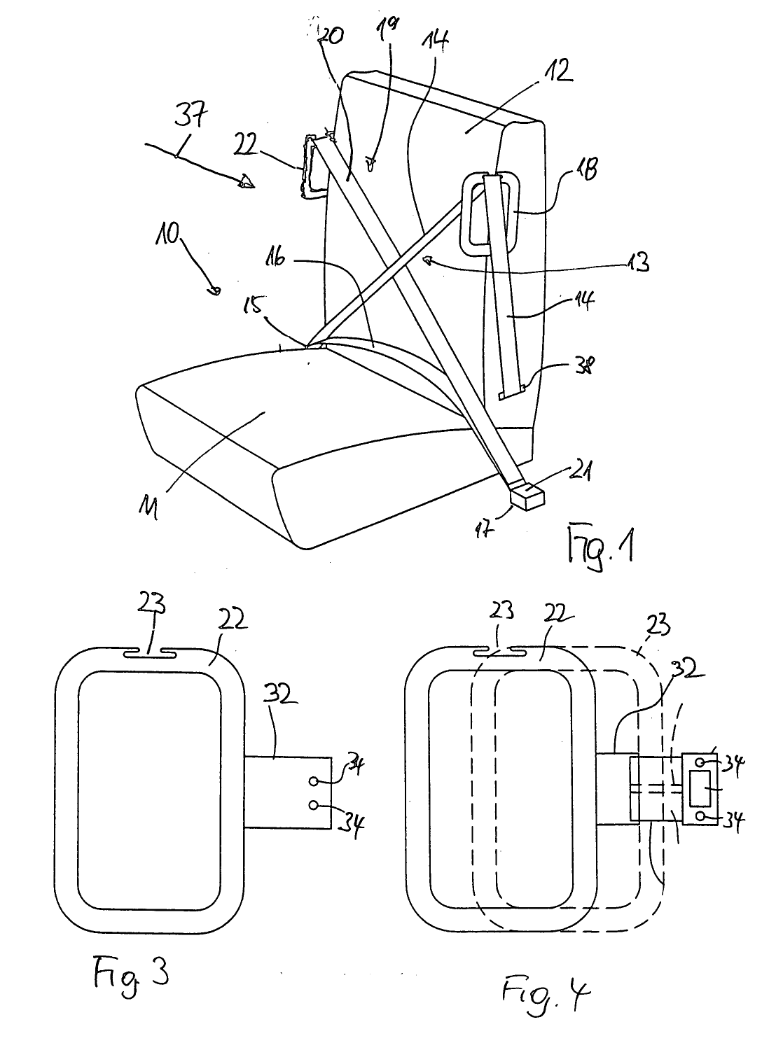

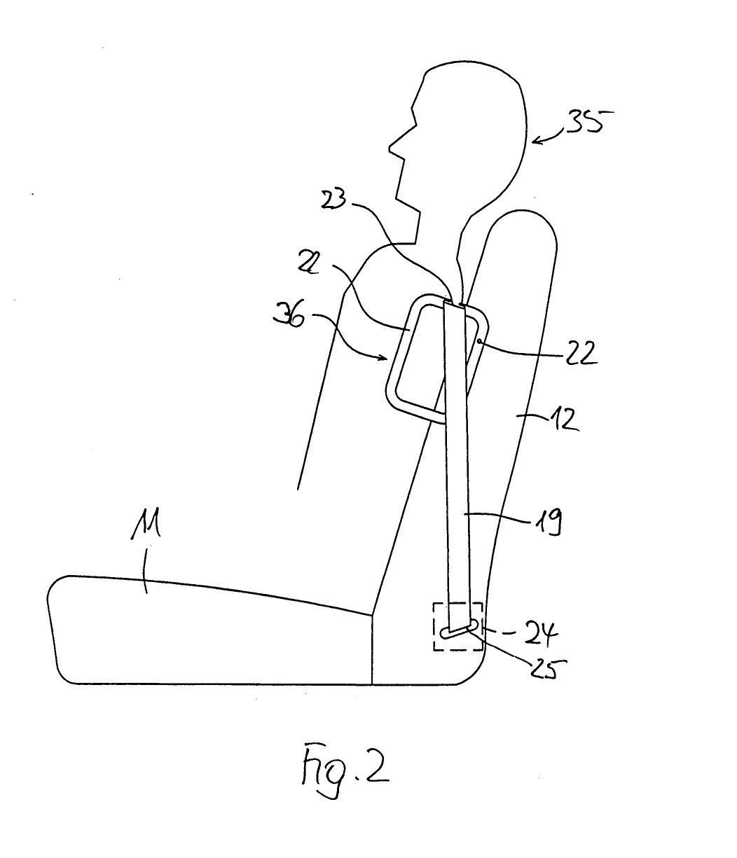

While, in FIG. 3, the frame 22 in its role as the inventive support device is configured with a fixed bracket 32 that is securable via securement holes 34 to the seat back 12, the bracket 32 of the frame 22 shown in the variation illustrated in FIG. 4 is configured as a displaceable bracket, whereby, in this configuration, the frame 22, in its non-deployed position, is, for the most part, positioned laterally or to the side of the seat back 12 and only upon its release from its non-deployed position, via displacement of the bracket 32, does the frame 22 assume its support position which is illustrated in FIGS. 1 and 2.

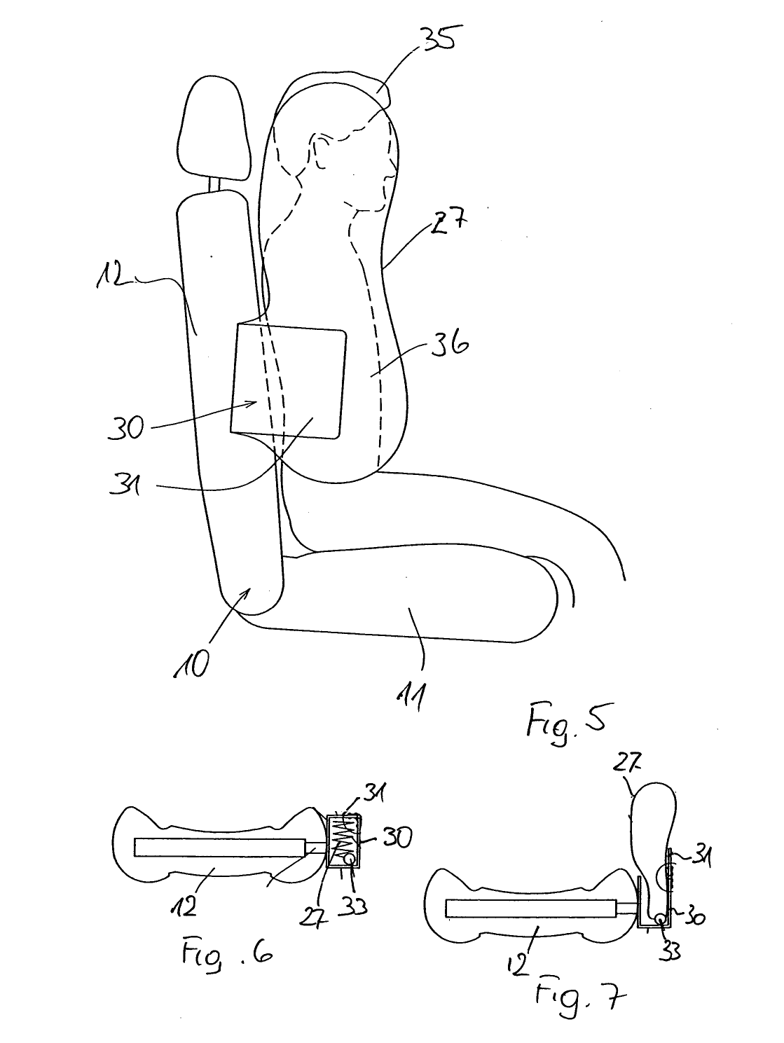

In the variation of the seat security arrangement shown in FIGS. 5-7, a support device 26 is comprised of an airbag 27, supported on the side of the seat back 12, that unfolds in the event of an impact, with the airbag being deployable out of an airbag module 30 itself mounted on the seat back 12 (FIGS. 6 and 7).to assume its deployed unfolded position shown in FIG. 5 and, thereby, to provide lateral support for the vehicle seat occupant 35. To improve the lateral support, the cover 31 of the airbag module 30, which is hingedly connected to the airbag module 30, is configured, as can be seen in FIGS. 6 and 7, such that the cover provides, after its opening, an additional lateral support for the airbag.

The specification incorporates by reference the disclosure of German priority document 203 14 924.6 filed 25 Sep. 2003.

The present invention is, of course, in no way restricted to the specific disclosure of the specification and drawings, but also encompasses any modifications within the scope of the appended claims.

1. A seat security arrangement for a vehicle seat occupant
sitting on a vehicle seat, the vehicle seat having a seat back and an outboard side and an inboard side located interiorly of the outboard side, the arrangement comprising:
a three-point safety belt having one extent forming a shoulder belt that extends from the outboard side of the vehicle seat to restrain one shoulder of the seat occupant and another extent forming a lap belt which extends across the abdomen of the seat occupant;
a two-point safety belt extending from the inboard side of the vehicle seat past the respective shoulder of the seat occupant not restrained by the three-point safety belt and thereafter crossing the shoulder belt of the three-point safety belt; and
a support device located in the respective region of the seat back turned toward the inboard side of the vehicle seat, the support device extending in the direction of the vehicle's forward travel so as provide lateral support to the upper torso of the seat occupant.

2. An arrangement according to claim 1, wherein the support device is a non-moving fixed support.

3. An arrangement according to claim 1, wherein the support device is configured as a frame which is mounted on the seat back laterally thereof.

4. An arrangement according to claim 1, wherein the support device is movable between a non-deployed position and a deployed support position, the support device assuming its deployed support position in the event of a detected impact against the vehicle.

5. An arrangement according to claim 4, wherein the support device is configured as a frame that, in its non-deployed position, assumes a rearward position with respect to the seat back and, in the event of an impact, is displaceable forwardly via a displacement movement into its deployed support position.

6. An arrangement according to claim 1, wherein the support device includes a belt guide for guiding the shoulder belt of the two-point safety belt.

7. An arrangement according to claim 1, wherein the support device includes an integrated airbag module with an airbag that unfolds out of the support device in the event of an impact.

8. An arrangement according to claim 1, wherein the support device is configured to yield.

9. An arrangement according to claim 1, wherein the support device includes a bracket that secures the support device to the seat back of the vehicle seat and the bracket is configured to yield.

10. An arrangement according to claim 1, wherein the support device is configured as an airbag that unfolds out of a side region of the seat back in a forward direction in the event of a detected impact.

11. An arrangement according to claim 10, wherein an airbag module that comprises the airbag is mounted on the side wall of the seat back and the airbag module further comprises a gas generator associated with the airbag for providing expansion gas thereto.

12. An arrangement according to claim 10, wherein the airbag module includes a housing in which the airbag is housed in its non-deployed folded condition, the housing having a cover hingedly connected thereto which opens in connection with the deployment of the airbag and the cover is configured such that the cover provides, after its opening, an additional lateral support for the airbag.
